(19) United States
(12) Patent Application Publication
(10) Pub. No.: US 2017/0308508 A1
(43) Pub. Date: Oct. 26, 2017

(54) DETECTION OF USER INTERFACE LAYOUT CHANGES

(71) Applicant: HEWLETT PACKARD ENTERPRISE DEVELOPMENT LP, Houston, TX (US)

(72) Inventors: Ofer SPIEGEL, Yehud (IL); Gil NAKACHE, Yehud (IL)

(73) Assignee: HEWLETT PACKARD ENTERPRISE DEVELOPMENT LP, Houston, TX (US)

(21) Appl. No.: 15/523,578

(22) PCT Filed: Nov. 24, 2014
(86) PCT No.: PCT/US2014/067071

§ 371 Date: May 1, 2017

(51) Int. Cl. G06F 17/21; G06F 3/0481; G06F 9/44

(52) U.S. Cl. CPC G06F 17/212; G06F 9/4443; G06F 3/0481; G06F 8/71

(57) ABSTRACT

Examples relate to detecting UI layout changes. The examples disclosed herein enable generating combinations of values from a set of context elements that define a UI layout for an application. Each value in a first combination of the combinations may be selected from values available for each context element of the set of context elements. The examples disclosed herein further enable obtaining a first UI to be displayed based on the first combination and retrieving a first set of layout attributes of the first UI.

### BACKGROUND

Many software applications can be customized to make the applications more convenient and user-friendly to users. In this way, users and businesses can benefit from a richer and more usable application experience. For example, the layout of the user interface (UI) of an application may be customized by defining or modifying layout attributes associated with various context elements that define the UI layout. When the customization made to the application is modified or the application is upgraded or otherwise modified, such modifications may inadvertently change the behavior of the application that was originally intended.

### BRIEF DESCRIPTION OF THE DRAWINGS

The following detailed description references the drawings, wherein:

FIG. 1 is a block diagram depicting an example environment in which various examples may be implemented as a UI layout changes detection system.

FIG. 2 is a block diagram depicting an example UI layout changes detection system.

FIG. 3 is a block diagram depicting an example machine-readable storage medium comprising instructions executable by a processor for detecting UI layout changes.

FIG. 4 is a block diagram depicting an example machine-readable storage medium comprising instructions executable by a processor for detecting UI layout changes.

FIG. 5 is a flow diagram depicting an example method for detecting UI layout changes.

FIG. 6 is a flow diagram depicting an example method for detecting UI layout changes.

FIG. 7 is a flow diagram depicting an example method for detecting UI layout changes.

FIG. 8 is a table depicting example context elements and their values available for selection.

FIG. 9 is a table depicting an example set of combinations of values generated from a set of context elements that define a UI layout for an application.

FIG. 10 is a table 1000 depicting example layout attributes retrieved from UIs that are obtained based on a set of combinations of values.

### DETAILED DESCRIPTION

The following detailed description refers to the accompanying drawings. Wherever possible, the same reference numbers are used in the drawings and the following description to refer to the same or similar parts. It is to be expressly understood, however, that the drawings are for the purpose of illustration and description only. While several examples are described in this document, modifications, adaptations, and other implementations are possible. Accordingly, the following detailed description does not limit the disclosed examples. Instead, the proper scope of the disclosed examples may be defined by the appended claims.

Many software applications can be customized to make the applications more convenient and user-friendly to users. In this way, users and businesses can benefit from a richer and more usable application experience. For example, the layout of the user interface (UI) of an application may be customized by defining or modifying layout attributes associated with various context elements that define the UI layout. When the customization made to the application is modified or the application is upgraded or otherwise modified, such modifications may inadvertently change the behavior of the application that was originally intended.

In order to ensure that the intended behavior of the application remains unchanged after such a modification, various regression tests may be performed. Such regression tests may be either performed manually or by running an automated functional test. However, even the automated test would still require manually recording multiple testing scenarios to properly test the modified or upgraded application in various contexts, resulting a slow and inefficient testing process.

Examples disclosed herein provide technical solutions to these technical problems by generating combinations of values from a set of context elements that define a UI layout for an application. Each value in a combination may be selected from values available for each context element of the set of context elements. As such, different combinations of values may be generated without repetition. A first UI that corresponds to a particular combination may be obtained before the application is modified. After the application has been modified, a second UI that corresponds to the same combination of values may be obtained. The first UI (and the layout attributes thereof) and second UI (and the layout attributes thereof) may be compared to detect a mismatch. In response to the detected mismatch, an alert may be generated.

The terminology used herein is for the purpose of describing particular embodiments only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “coupled,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, third, etc. may be used herein to describe various elements, these elements should not be limited by these terms, as these terms are only used to distinguish one element from another unless stated otherwise or the context indicates otherwise.

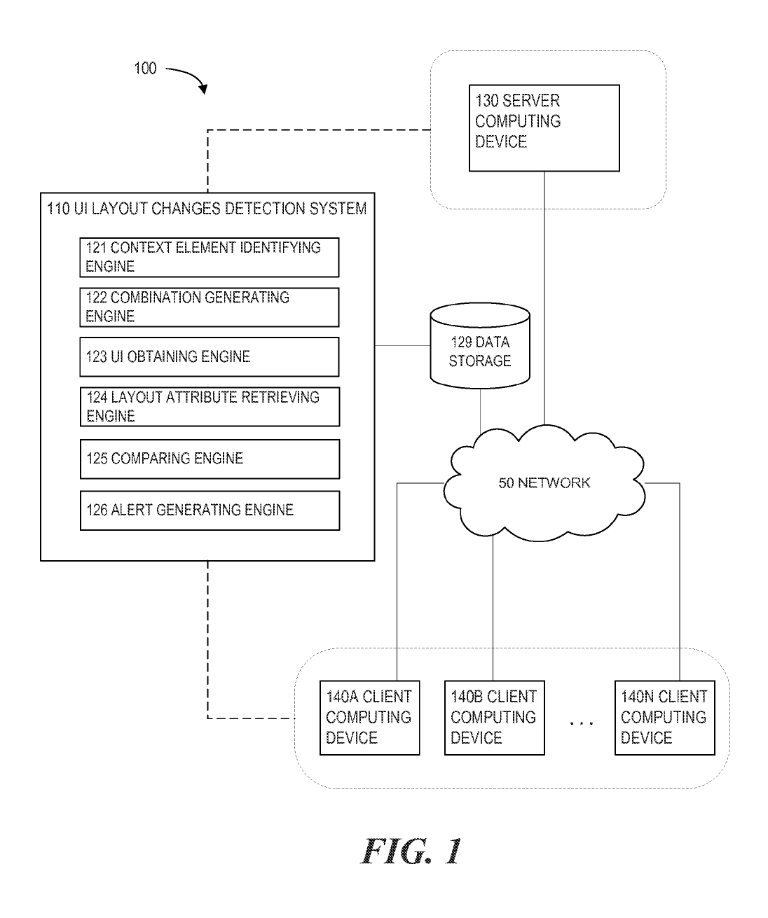

FIG. 1 is an example environment 100 in which various examples may be implemented as a UI layout changes detection system 110. Environment 100 may include various components including server computing device 130 and client computing devices 140 (illustrated as 140A, 140B, . . . , 140N). Each client computing device 140A, 140B, . . . , 140N may communicate requests to and/or receive responses from server computing device 130. Server computing device 130 may receive and/or respond to requests from client computing devices 140. Client computing devices 140 may be any type of computing device providing a user interface through which a user can interact with a software application. For example, client computing devices 140 may include a laptop computing device, a desktop computing device, an all-in-one computing device, a tablet computing device, a mobile phone, an electronic book reader, a network-enabled appliance such as a “Smart” television, and/or other electronic device suitable for displaying a user interface and processing user interactions with the displayed interface. While server computing device 130 is depicted as a single computing device, server computing device 130 may include any number of integrated or distributed computing devices serving at least one software application for consumption by client computing devices 140.

The various components (e.g., components 129, 130, and/or 140) depicted in FIG. 1 may be coupled to at least one other component via a network 50. Network 50 may comprise any infrastructure or combination of infrastructures that enable electronic communication between the components. For example, network 50 may include at least one of the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. According to various implementations, UI layout changes detection system 110 and the various components described herein may be implemented in hardware and/or a combination of hardware and programming that configures hardware. Furthermore, in FIG. 1 and other Figures described herein, different numbers of components or entities than depicted may be used.

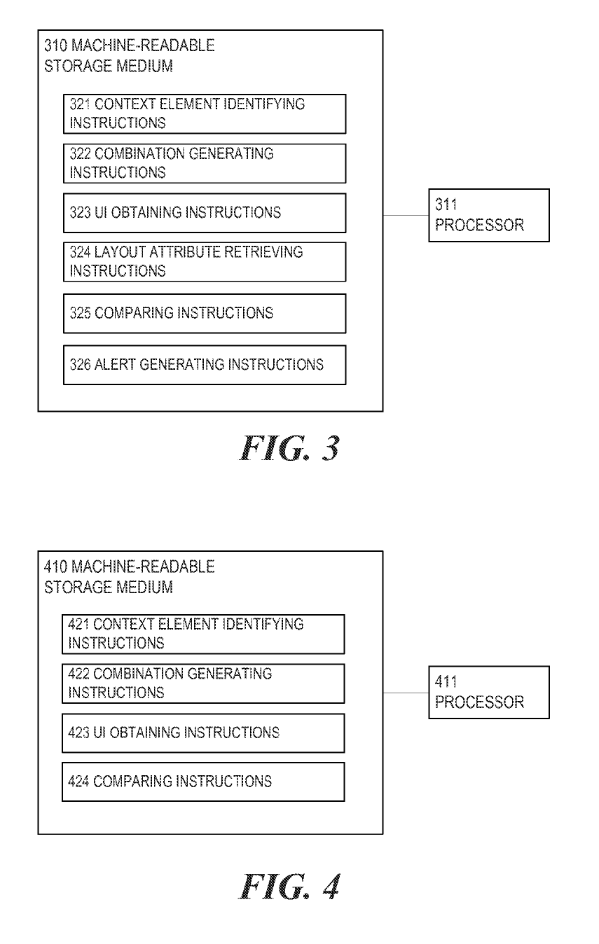

UI layout changes detection system 110 may comprise a context element identifying engine 121, a combination generating engine 122, a UI obtaining engine 123, a layout attribute retrieving engine 124, a comparing engine 125, an alert generating engine 126, and/or other engines. The term “engine”, as used herein, refers to a combination of hardware and programming that performs a designated function. As is illustrated respect to FIGS. 3-4, the hardware of each engine, for example, may include one or both of a processor and a machine-readable storage medium, while the programming is instructions or code stored on the machine-readable storage medium and executable by the processor to perform the designated function.

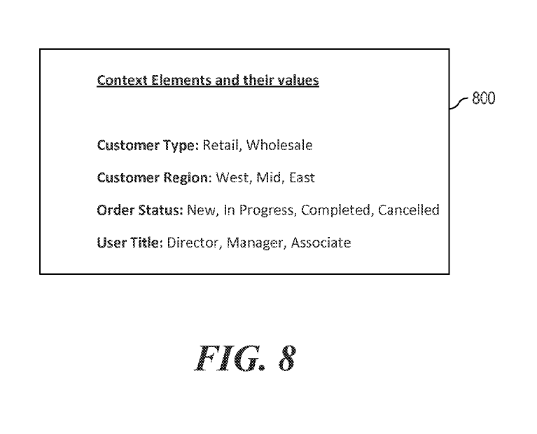

Context element identifying engine 121 may identify a set of context elements that define (or are otherwise related to) a user interface (UI) layout for an application. As used herein, an “application” may comprise any software program. As used herein, a set of “context elements” may include a UI element and/or a non-UI element. The UI element may refer to a data element that may be displayed in the UI. The UI element may be associated with layout attributes and values that are available for that UI element. For example, the UI elements such as the “Customer Type,” “Customer Region,” and “Order Status” may be displayed as fields in an electronic “Order” form. Each of the fields may be associated with layout attributes such as a label (e.g., field label), a location or position (e.g., tab order), an editable attribute (e.g., an indication of whether the field is read-only), an optional attribute (e.g., an indication of whether the field is required), and/or other attributes that define the UI layout. Each of the fields may be associated with values that are available for selection (e.g., system-selected or user-selected). For example, the “Customer Type” field may be associated with two available values including “Retail” and “Wholesale.” The UI may display one radio button indicating “Retail” and another radio button indicating “Wholesale.” Other example values for each of the context elements described above are illustrated in FIG. 8.

The non-UI element, although not displayed in the UI, may nevertheless define the UI layout based on a value assigned to the non-UI element. For example, the non-UI element may include user information (e.g., user ID, user roles, user titles, a department or organization that the user belongs to, etc.). The UI layout may be different based on the identification of an individual user, a particular title or role of the user (e.g., the “User Title” element in FIG. 8), a particular department or organization that the user belongs to, etc. For example, the user who is a manager (e.g., a first value for the non-UI element) may be presented with a UI layout that is different from the one that is presented to the user who is an associate (e.g., a second value for the non-UI element).

The set of context elements and/or the values available for each of the set of context elements may be automatically generated and/or defined by system 110 and/or external systems or manually generated and/or defined based on user input. In one example, the context elements such as the “Customer Type,” “Customer Region,” “Order Status,” etc. and/or their values may be received from an external system that processes customer orders. In another example, a user (e.g., system administrator) may specify the set of context elements and/or their values via system 110.

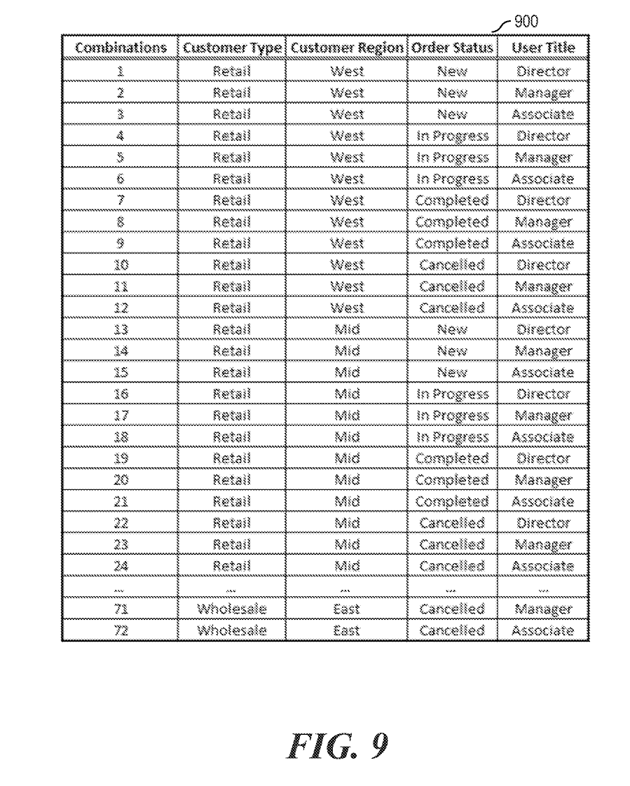

Combination generating engine 122 may generate a set of combinations of values from the context elements (e.g., identified by context element identifying engine 121). Each value in a combination of the set of combinations is selected from values available for each context element. In other words, using the values available for each context element, combination generating engine 122 may generate different combinations without repetition. As such, the set of combinations may comprise a first combination that includes at least one value that is different from a second combination or the rest of the combinations in the set of combinations. In the example illustrated in FIG. 9, Combination 1 is different from Combination 3 that the value (e.g., “Director”) of the “User Title” context element for Combination 1 is different from the value (e.g., “Associate”) of the “User Title” context element for Combination 3.

Further, the number of combinations that are generated may be equal to the product of the number of the available values for each context element. The set of context elements may include, for example, 4 context elements such as the “Customer Type,” “Customer Region,” “Order Status,” and “User Title.” The “Customer Type” may be associated with 2 values (e.g., Retail and Wholesale) available for selection. The “Customer Region” may be associated with 3 available values (e.g., West, Mid, and East). The “Order Status” may be associated with 4 available values (e.g., New, In Progress, Completed, and Cancelled). The “User Title” may be associated with 3 available values (e.g., Director, Manager, and Associate). In this example, combination generating engine 122 may generate 72 different combinations of values (e.g., 2*3*4*3=72). An example set of combinations described above is illustrated in FIG. 9.

UI obtaining engine 123 may obtain a first set of UIs corresponding to the set of combinations (e.g., generated by combination generating engine 122). For each combination of the set of combinations, UI obtaining engine 123 may obtain a UI that corresponds to that particular combination of values. In some instances, the application may be modified, for example, when the application is upgraded or the customization made to the application is re-written, re-defined, or otherwise modified. After the application has been modified, UI obtaining engine 123 may obtain a second set of UIs corresponding to the same set of combinations. As discussed herein with respect to comparing engine 125, the first set of UIs (e.g., obtained before the modification of the application) and the second set of UIs (e.g., obtained after the modification of the application) may be compared to detect a mismatch. This comparison or verification is to help ensure that the intended behavior of the application remains unchanged after such a modification.

In some implementations, a data storage (e.g., a data storage 129) may store UI records each of which corresponds to a particular combination of values. For each combination of the set of combinations, UI obtaining engine 123 may retrieve, from the data storage, a UI record that corresponds to that particular combination of values. The data storage may also store another set of UI records of the application after the application has been modified. For each combination of the same set of combinations, UI obtaining engine 123 may retrieve, from the data storage, a UI record that was captured after the modification of the application.

In some implementations, UI obtaining engine 123 may generate the UI by applying the particular combination of values to the application. For example, the particular combination of values may be entered into the application and the resulting UI that is displayed may be obtained. Similarly, UI obtaining engine 123 may generate another UI by applying the particular combination of values to the modified application. For example, the particular combination of values may be entered into the modified application and the resulting UI that is displayed may be obtained.

Note that the UI (and its layout) may vary depending on what values are selected (e.g., system-selected or user-selected) for each context element. For example, the set of context elements may include a first context element where the first context element has a first set of values available for selection. Based on the value that has been selected for the first context element, layout attributes associated with a second context element of the set of context elements may be determined. For example, the UI to be displayed may be different based on whether the user selects the value “Retail” versus the value “Wholesale” for the “Customer Type” context element. Based on the selection of the value, the layout attributes associated with another context element of the set of the context elements may be determined.

Layout attribute retrieving engine 124 may retrieve a set of layout attributes of the UI (e.g., obtained by UI obtaining engine 123 based on a particular combination of the set of combinations). The set of layout attributes may include layout attributes associated with at least one UI element in the UI. For example, as described above, each of the UI elements (e.g., fields displayed in the UI) may be associated with the layout attributes such as a label (e.g., field label), a location or position (e.g., tab order), an editable attribute (e.g., an indication of whether the field is read-only), an optional attribute (e.g., an indication of whether the field is required), and/or other attributes that define the UI layout.

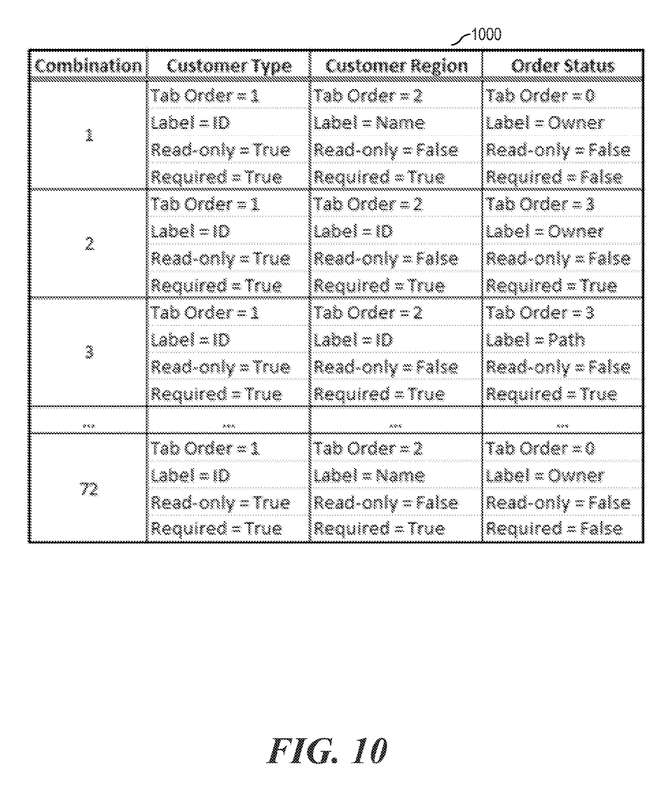

When there are multiple combinations (e.g., a first combination and a second combination) in the set of combinations, layout attribute retrieving engine 124 may retrieve a set of layout attributes for each combination. For example, when a first UI is obtained by UI obtaining engine 123 based on the first combination, layout attribute retrieving engine 124 may retrieve the layout attributes from the first UI. Similarly, layout attribute retrieving engine 124 may retrieve the layout attributes from a second UI that has been obtained by UI obtaining engine 123 based on the second combination. The retrieved layout attributes and/or their association to a particular combination in the set of combinations may be stored in a data storage (e.g., data storage 129). Example layout attributes retrieved for individual combinations of values are illustrated in FIG. 10.

Comparing engine 125 may compare the first set of UIs (e.g., obtained by UI obtaining engine 123 before the modification of the application) with the second set of UIs (e.g., obtained by UI obtaining engine 123 after the modification of the application) to detect a mismatch. This comparison or verification is to help ensure the intended behavior of the application remains unchanged after such a modification. For example, the first set of UIs may include a first UI that was obtained based on a particular combination of values of the set of combinations. The first UI may comprise a first set of layout attributes (e.g., retrieved by layout attribute retrieving engine 124). Similarly, the second set of UIs may include a second UI that was obtained based on the same combination where the second UI comprises a second set of layout attributes (e.g., retrieved by layout attribute retrieving engine 124). During the comparison, the first set of layout attributes and second set of layout attributes may be compared to detect a mismatch. In doing so, a first layout attribute of a context element in the first UI may be compared with a second layout attribute of the same context element in the second UI.

Using the example illustrated in FIG. 10, the first layout attribute may be the “Tab Order” in Field 1 for Combination 1 that was retrieved for the application before the modification. The second layout attribute, on the other hand, may be the “Tab Order” in Field 1 for Combination 1 that was retrieved for the application after the modification. The “Tab Order” attributes may be compared, in this example, to determine whether the attributes (or the values thereof) are different from each other. In another example, the first layout attribute may be the “Read-only” attribute in Field 2 for Combination 3 that was retrieved for the application before the modification while the second layout attribute may be the “Read-only” attribute in Field 2 for Combination 3 that was retrieved for the application after the modification. These attributes may be compared to determine whether the attributes (or the values thereof) are different from each other. In this example, if one attribute indicates “True” while the other attribute indicates “False,” the mismatch may be detected.

Alert generating engine 126 may generate an alert based on the detected mismatch. In this way, the user who receives the alert may take necessary changes to the application and/or UI layout. In some implementations, the alert may indicate the context element in which the mismatch has been detected. Returning to the example above, the alert may indicate that the mismatch has been detected in the “Read-only” attribute in Field 2 of the UI. The alert may also indicate the values in the combination (e.g., Combination 3) that caused this mismatch.

In performing their respective functions, engines 121-126 may access data storage 129 and/or other suitable database(s). Data storage 129 may represent any memory accessible to UI layout changes detection system 110 that can be used to store and retrieve data. Data storage 129 and/or other database may comprise random access memory (RAM), read-only memory (ROM), electrically-erasable programmable read-only memory (EEPROM), cache memory, floppy disks, hard disks, optical disks, tapes, solid state drives, flash drives, portable compact disks, and/or other storage media for storing computer-executable instructions and/or data. UI layout changes detection system 110 may access data storage 129 locally or remotely via network 50 or other networks.

Data storage 129 may include a database to organize and store data. The database may reside in a single or multiple physical device(s) and in a single or multiple physical location(s). The database may store a plurality of types of data and/or files and associated data or file description, administrative information, or any other data.

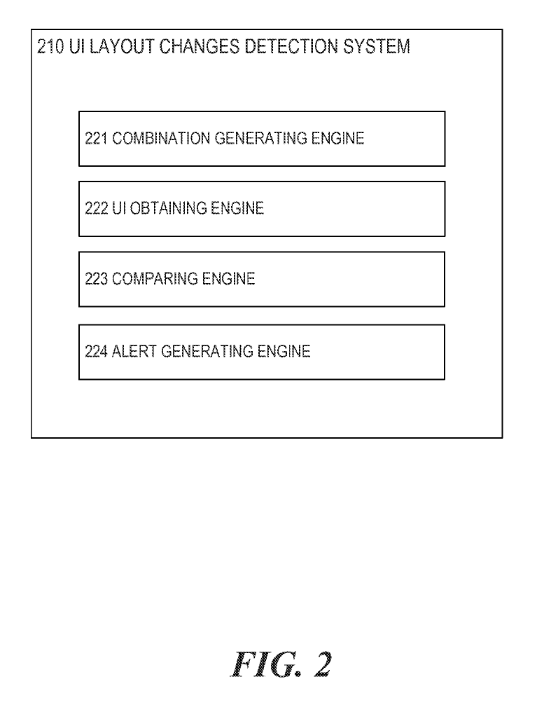

FIG. 2 is a block diagram depicting an example UI layout changes detection system 210. UI layout changes detection system 210 may comprise a combination generating engine 221, a UI obtaining engine 222, a comparing engine 223, an alert generating engine 224, and/or other engines. Engines 221-224 represent engines 122, 123, 125, and 126, respectively.

FIG. 3 is a block diagram depicting an example machine-readable storage medium 310 comprising instructions executable by a processor for detecting UI layout changes.

In the foregoing discussion, engines 121-126 were described as combinations of hardware and programming. Engines 121-126 may be implemented in a number of fashions. Referring to FIG. 3, the programming may be processor executable instructions 321-326 stored on a machine-readable storage medium 310 and the hardware may include a processor 311 for executing those instructions. Thus, machine-readable storage medium 310 can be said to store program instructions or code that when executed by processor 311 implements UI layout changes detection system 110 of FIG. 1.

In FIG. 3, the executable program instructions in machine-readable storage medium 310 are depicted as context element identifying instructions 321, combination generating instructions 322, UI obtaining instructions 323, UI scanning instructions 324, comparing instructions 325, and alert generating instructions 326. Instructions 321-326 represent program instructions that, when executed, cause processor 311 to implement engines 121-126, respectively.

FIG. 4 is a block diagram depicting an example machine-readable storage medium 410 comprising instructions executable by a processor for detecting UI layout changes.

In the foregoing discussion, engines 121-126 were described as combinations of hardware and programming. Engines 121-126 may be implemented in a number of fashions. Referring to FIG. 4, the programming may be processor executable instructions 421-424 stored on a machine-readable storage medium 410 and the hardware may include a processor 411 for executing those instructions. Thus, machine-readable storage medium 410 can be said to store program instructions or code that when executed by processor 411 implements UI layout changes detection system 110 of FIG. 1.

In FIG. 4, the executable program instructions in machine-readable storage medium 410 are depicted as context element identifying instructions 421, combination generating instructions 422, UI obtaining instructions 423, and comparing instructions 424. Instructions 421-424 represent program instructions that, when executed, cause processor 411 to implement engines 121, 122, 123, and 125, respectively.

Machine-readable storage medium 310 (or machine-readable storage medium 410) may be any electronic, magnetic, optical, or other physical storage device that contains or stores executable instructions. In some implementations, machine-readable storage medium 310 (or machine-readable storage medium 410) may be a non-transitory storage medium, where the term “non-transitory” does not encompass transitory propagating signals. Machine-readable storage medium 310 (or machine-readable storage medium 410) may be implemented in a single device or distributed across devices. Likewise, processor 311 (or processor 411) may represent any number of processors capable of executing instructions stored by machine-readable storage medium 310 (or machine-readable storage medium 410). Processor 311 (or processor 411) may be integrated in a single device or distributed across devices. Further, machine-readable storage medium 310 (or machine-readable storage medium 410) may be fully or partially integrated in the same device as processor 311 (or processor 411), or it may be separate but accessible to that device and processor 311 (or processor 411).

In one example, the program instructions may be part of an installation package that when installed can be executed by processor 311 (or processor 411) to implement UI layout changes detection system 110. In this case, machine-readable storage medium 310 (or machine-readable storage medium 410) may be a portable medium such as a floppy disk, CD, DVD, or flash drive or a memory maintained by a server from which the installation package can be downloaded and installed. In another example, the program instructions may be part of an application or applications already installed. Here, machine-readable storage medium 310 (or machine-readable storage medium 410) may include a hard disk, optical disk, tapes, solid state drives, RAM, ROM, EEPROM, or the like.

Processor 311 may be at least one central processing unit (CPU), microprocessor, and/or other hardware device suitable for retrieval and execution of instructions stored in machine-readable storage medium 310. Processor 311 may fetch, decode, and execute program instructions 321-326, and/or other instructions. As an alternative or in addition to retrieving and executing instructions, processor 311 may include at least one electronic circuit comprising a number of electronic components for performing the functionality of at least one of instructions 321-326, and/or other instructions.

Processor 411 may be at least one central processing unit (CPU), microprocessor, and/or other hardware device suitable for retrieval and execution of instructions stored in machine-readable storage medium 410. Processor 411 may fetch, decode, and execute program instructions 421-424, and/or other instructions. As an alternative or in addition to retrieving and executing instructions, processor 411 may include at least one electronic circuit comprising a number of electronic components for performing the functionality of at least one of instructions 421-424, and/or other instructions.

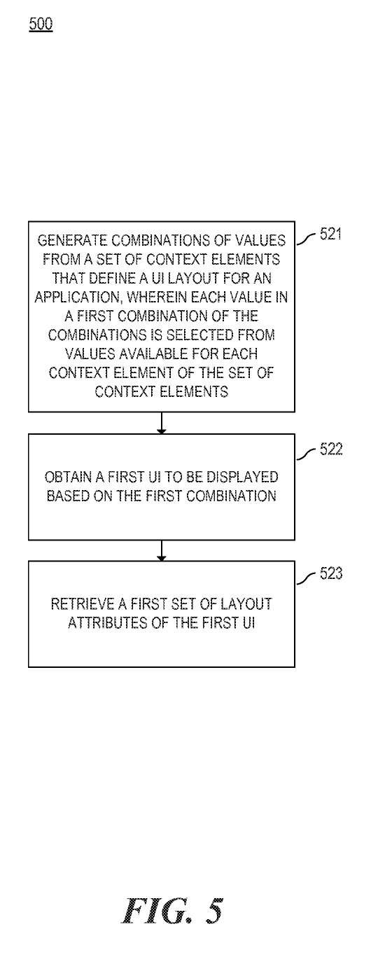

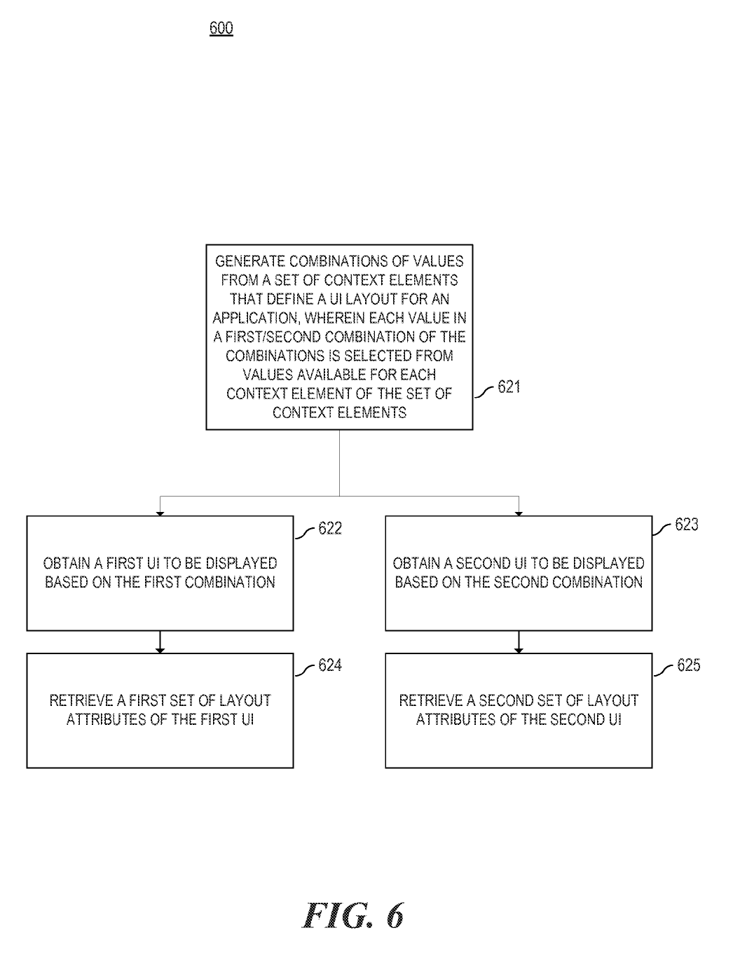

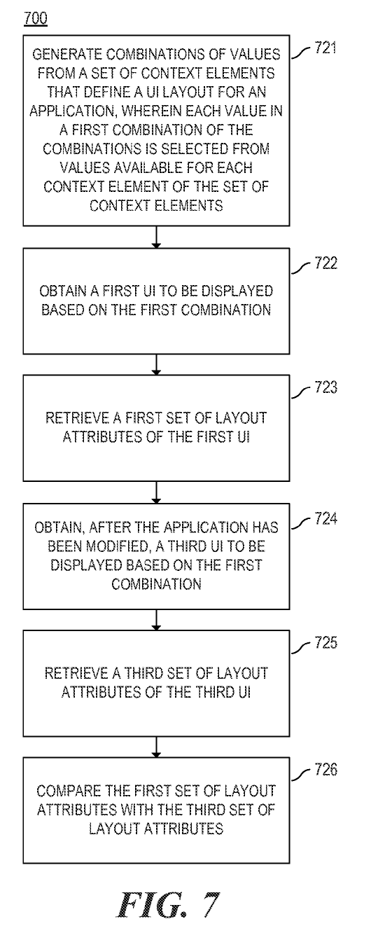

FIG. 5 is a flow diagram depicting an example method 500 for detecting UI layout changes. The various processing blocks and/or data flows depicted in FIG. 5 (and in the other drawing figures such as FIGS. 6 and 7) are described in greater detail herein. The described processing blocks may be accomplished using some or all of the system components described in detail above and, in some implementations, various processing blocks may be performed in different sequences and various processing blocks may be omitted. Additional processing blocks may be performed along with some or all of the processing blocks shown in the depicted flow diagrams. Some processing blocks may be performed simultaneously. Accordingly, method 500 as illustrated (and described in greater detail below) is meant be an example and, as such, should not be viewed as limiting. Method 500 may be implemented in the form of executable instructions stored on a machine-readable storage medium, such as storage medium 310, and/or in the form of electronic circuitry.

Method 500 may start in block 521 where method 500 generates combinations of values from a set of context elements that define a UI layout for an application. Each value in a first combination of the combinations is selected from values available for each context element of the set of context elements. In other words, using the values available for each context element, method 500 may generate different combinations without repetition. As such, the set of combinations may comprise the first combination that includes at least one value that is different from a second combination or the rest of the combinations. In the example illustrated in FIG. 9, Combination 1 is different from Combination 3 that the value (e.g., “Director”) of the “User Title” context element for Combination 1 is different from the value (e.g., “Associate”) of the “User Title” context element for Combination 3.

In block 522, method 500 may obtain a first UI to be displayed based on the first combination. In some implementations, a data storage (e.g., data storage 129 in FIG. 1) may store the first UI that corresponds to the first combination of values. In this case, method 500 may retrieve, from the data storage, the first UI. In some implementations, method 500 may generate the first UI by applying the first combination of values to the application. For example, the first combination may be entered into the application and the resulting UI to be displayed may be obtained.

In block 523, method 500 may retrieve a first set of layout attributes of the first UI. The first set of layout attributes may include layout attributes associated with at least one UI element in the first UI. For example, the UI element (e.g., “Customer Type” field in FIG. 10) may be associated with the layout attributes such as a label (e.g., field label), a location or position (e.g., tab order), an editable attribute (e.g., an indication of whether the field is read-only), an optional attribute (e.g., an indication of whether the field is required), and/or other attributes that define the UI layout.

Referring back to FIG. 1, combination generating engine 122 may be responsible for implementing block 521. UI obtaining engine 123 may be responsible for implementing block 522. Layout attribute retrieving engine 124 may be responsible for implementing block 523.

FIG. 6 is a flow diagram depicting an example method 600 for detecting UI layout changes. Method 600 as illustrated (and described in greater detail below) is meant be an example and, as such, should not be viewed as limiting. Method 600 may be implemented in the form of executable instructions stored on a machine-readable storage medium, such as storage medium 210, and/or in the form of electronic circuitry.

Method 600 may start in block 621 where method 600 generates combinations of values from a set of context elements that define a UI layout for an application. Each value in a first combination of the combinations is selected from values available for each context element of the set of context elements. Similarly, each value in a second combination of the combinations is selected from the values available for each context element of the set of context elements. The second combination, however, includes at least one value that is different from the first combination. In other words, using the values available for each context element, method 600 may generate different combinations without repetition. In the example illustrated in FIG. 9, Combination 1 is different from Combination 3 that the value (e.g., “Director”) of the “User Title” context element for Combination 1 is different from the value (e.g., “Associate”) of the “User Title” context element for Combination 3.

In block 622, method 600 may obtain a first UI to be displayed based on the first combination. In block 623, method 600 may obtain a second UI to be displayed based on the second combination. In some implementations, a data storage (e.g., data storage 129 in FIG. 1) may store the first UI that corresponds to the first combination and the second UI that corresponds to the second combination. In this case, method 600 may retrieve, from the data storage, the first UI and the second UI. In some implementations, method 600 may generate the first UI by applying the first combination of values to the application. For example, the first combination may be entered into the application and the resulting UI to be displayed may be obtained. Similarly, the second UI may be generated by applying the second combination of values to the application.

Method 600 may retrieve a first set of layout attributes of the first UI (block 624) and a second set of layout attributes of the second UI (block 625). The first or second set of layout attributes may include layout attributes associated with at least one UI element in the corresponding UI. For example, the UI element (e.g., “Customer Type” field in FIG. 10) may be associated with the layout attributes such as a label (e.g., field label), a location or position (e.g., tab order), an editable attribute (e.g., an indication of whether the field is read-only), an optional attribute (e.g., an indication of whether the field is required), and/or other attributes that define the UI layout.

Referring back to FIG. 1, combination generating engine 122 may be responsible for implementing block 621. UI obtaining engine 123 may be responsible for implementing blocks 622 and 623. Layout attribute retrieving engine 124 may be responsible for implementing blocks 624 and 625.

FIG. 7 is a flow diagram depicting an example method 700 for detecting UI layout changes. Method 700 as illustrated (and described in greater detail below) is meant be an example and, as such, should not be viewed as limiting. Method 700 may be implemented in the form of executable instructions stored on a machine-readable storage medium, such as storage medium 210, and/or in the form of electronic circuitry.

Method 700 may start in block 721 where method 700 generates combinations of values from a set of context elements that define a UI layout for an application. Each value in a first combination of the combinations is selected from values available for each context element of the set of context elements. In other words, using the values available for each context element, method 700 may generate different combinations without repetition. As such, the set of combinations may comprise the first combination that includes at least one value that is different from a second combination or the rest of the combinations. In the example illustrated in FIG. 9, Combination 1 is different from Combination 3 that the value (e.g., “Director”) of the “User Title” context element for Combination 1 is different from the value (e.g., “Associate”) of the “User Title” context element for Combination 3.

In block 722, method 700 may obtain a first UI to be displayed based on the first combination. In some implementations, a data storage (e.g., data storage 129 in FIG. 1) may store the first UI that corresponds to the first combination of values. In this case, method 700 may retrieve, from the data storage, the first UI. In some implementations, method 700 may generate the first UI by applying the first combination of values to the application. For example, the first combination may be entered into the application and the resulting UI to be displayed may be obtained.

In block 723, method 700 may retrieve a first set of layout attributes of the first UI. The first set of layout attributes may include layout attributes associated with at least one UI element in the first UI. For example, the UI element (e.g., “Customer Type” field in FIG. 10) may be associated with the layout attributes such as a label (e.g., field label), a location or position (e.g., tab order), an editable attribute (e.g., an indication of whether the field is read-only), an optional attribute (e.g., an indication of whether the field is required), and/or other attributes that define the UI layout.

In block 724, method 700 may obtain, after the application has been modified, a third UI to be displayed based on the first combination. In some implementations, the data storage may store the third UI that was captured after the application has been modified. In this case, method 700 may retrieve, from the data storage, the third UI. In some implementations, method 700 may generate the third UI by applying the first combination of values to the modified application. For example, the first combination may be entered into the modified application and the resulting UI to be displayed may be obtained.

In block 725, method 700 may retrieve a third set of layout attributes of the third UI. The third set of layout attributes may include layout attributes associated with at least one UI element in the third UI.

In block 726, method 700 may compare the first set of layout attributes with the third set of layout attributes. This comparison is to help ensure the intended behavior of the application remains unchanged after the application has been modified. During the comparison, a first layout attribute of a context element in the first UI may be compared with a second layout attribute of the same context element in the second UI.

Using the example illustrated in FIG. 10, the first layout attribute may be the “Tab Order” in Field 1 for Combination 1 that was retrieved for the application before the modification. The second layout attribute, on the other hand, may be the “Tab Order” in Field 1 for Combination 1 that was retrieved for the application after the modification. The “Tab Order” attributes may be compared, in this example, to determine whether the attributes (or the values thereof) are different from each other. In another example, the first layout attribute may be the “Read-only” attribute in Field 2 for Combination 3 that was retrieved for the application before the modification while the second layout attribute may be the “Read-only” attribute in Field 2 for Combination 3 that was retrieved for the application after the modification. These attributes may be compared to determine whether the attributes (or the values thereof) are different from each other. In this example, if one attribute indicates “True” while the other attribute indicates “False,” the mismatch may be detected.

Referring back to FIG. 1, combination generating engine 122 may be responsible for implementing block 721. UI obtaining engine 123 may be responsible for implementing blocks 722 and 724. Layout attribute retrieving engine 124 may be responsible for implementing blocks 723 and 725. Comparing engine 125 may be responsible for implementing block 726.

FIG. 8 is a table 800 depicting example context elements and their values available for selection. A set of context elements may include a UI element and/or a non-UI element. The UI element may refer to a data element that may be displayed in the UI. The UI element may be associated with layout attributes and values that are available for that UI element. In the example illustrated in FIG. 8, the UI elements such as the “Customer Type,” “Customer Region,” and “Order Status” may be displayed as fields in an electronic “Order” form. Each of the fields may be associated with layout attributes such as a label (e.g., field label), a location or position (e.g., tab order), an editable attribute (e.g., an indication of whether the field is read-only), an optional attribute (e.g., an indication of whether the field is required), and/or other attributes that define the UI layout. Each of the fields may be associated with values that are available for selection (e.g., system-selected or user-selected). For example, the “Customer Type” field may be associated with two available values including “Retail” and “Wholesale.” The UI may display one radio button indicating “Retail” and another radio button indicating “Wholesale.”

The non-UI element, although not displayed in the UI, may nevertheless define the UI layout based on a value assigned to the non-UI element. For example, the non-UI element may include user information (e.g., user ID, user roles, user titles, a department or organization that the user belongs to, etc.). The UI layout may be different based on the identification of an individual user, a particular title or role of the user (e.g., the “User Title” element in FIG. 8), a particular department or organization that the user belongs to, etc. For example, the user who is a manager (e.g., a first value for the “User Title” element may be presented with a UI layout that is different from the one that is presented to the user who is an associate (e.g., a second value for the “User Title” element).

FIG. 9 is a table 900 depicting an example set of combinations of values generated from a set of context elements that define a UI layout for an application. Each value in a combination of the set of combinations is selected from values available for each context element. In other words, using the values available for each context element, different combinations may be generated without repetition. As such, the set of combinations may comprise a first combination that includes at least one value that is different from a second combination or the rest of the combinations in the set of combinations. In the example illustrated in FIG. 9, Combination 1 is different from Combination 3 that the value (e.g., “Director”) of the “User Title” context element for Combination 1 is different from the value (e.g., “Associate”) of the “User Title” context element for Combination 3.

Further, the number of combinations that are generated may be equal to the product of the number of the available values for each context element. The set of context elements may include, for example, 4 context elements such as the “Customer Type,” “Customer Region,” “Order Status,” and “User Title,” as illustrated in FIG. 9. The “Customer Type” may be associated with 2 values (e.g., Retail and Wholesale) available for selection. The “Customer Region” may be associated with 3 available values (e.g., West, Mid, and East). The “Order Status” may be associated with 4available values (e.g., New, In Progress, Completed, and Cancelled). The “User Title” may be associated with 3 available values (e.g., Director, Manager, and Associate). In this example, 72 different combinations of values (e.g., 2*3*4*3=72) may be generated.

FIG. 10 is a table 1000 depicting example layout attributes retrieved from UIs that are obtained based on a set of combinations of values. In the example illustrated in FIG. 10, the set of combinations includes 72 different combinations of values. For each combination of the 72 combinations, a set of layout attributes may be retrieved from a UI that corresponds to that particular combination of values. The set of layout attributes may include layout attributes associated with at least one UI element in the UI. For example, each of the UI elements (e.g., “Customer Type,” “Customer Region,” and “Order Status”) may be associated with the layout attributes such as a label (e.g., field label), a location or position (e.g., tab order), an editable attribute (e.g., an indication of whether the field is read-only), an optional attribute (e.g., an indication of whether the field is required), and/or other attributes that define the UI layout.

The foregoing disclosure describes a number of example implementations for detection of UI layout changes. The disclosed examples may include systems, devices, computer-readable storage media, and methods for detection of UI layout changes. For purposes of explanation, certain examples are described with reference to the components illustrated in FIGS. 1-4. The functionality of the illustrated components may overlap, however, and may be present in a fewer or greater number of elements and components.

Further, all or part of the functionality of illustrated elements may co-exist or be distributed among several geographically dispersed locations. Moreover, the disclosed examples may be implemented in various environments and are not limited to the illustrated examples. Further, the sequence of operations described in connection with FIGS. 5-7 are examples and are not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples. All such modifications and variations are intended to be included within the scope of this disclosure and protected by the following claims.

1. A method for execution by a computing device for detecting user interface (UI) layout changes, the method comprising:
generating combinations of values from a set of context elements that define a UI layout for an application, wherein each value in a first combination of the combinations is selected from values available for each context element of the set of context elements;
obtaining a first UI to be displayed based on the first combination; and
retrieving a first set of layout attributes of the first UI.

2. The method of claim 1, wherein each value in a second combination of the combinations is selected from the values available for each context element of the set of context elements, the second combination including at least one value that is different from the first combination, further comprising:
obtaining a second UI to be displayed based on the second combination; and
retrieving a second set of layout attributes of the second UI.

3. The method of claim 1, further comprising:
obtaining, after the application has been modified, a third UI to be displayed based on the first combination;
retrieving a third set of layout attributes of the third UI; and
comparing the first set of layout attributes with the third set of layout attributes.

4. The method of claim 1, wherein a context element of the set of context elements comprises a UI element to be displayed in the first UI, wherein the UI element is associated with layout attributes and values that are available for input.

5. The method of claim 4, wherein retrieving the first set of layout attributes of the first UI comprises:
retrieving the layout attributes of the UI element in the first UI.

6. The method of claim 4, wherein a context element of the set of context elements comprises a non-UI element, wherein the UI layout is customized based on a value assigned to the non-UI element.

7. A non-transitory machine-readable storage medium comprising instructions executable by a processor of a computing device for detecting user interface (UI) layout changes, the machine-readable storage medium comprising:
instructions to identify a set of context elements related to a UI layout for an application;
instructions to generate a first combination of values, each value of the first combination of values selected from values available for each context element of the set of context elements;
instructions to obtain a first UI based on the first combination of values, the first UI comprising a first set of layout attributes;
instructions to obtain, after the application has been modified, a second UI based on the first combination of values, the second UI comprising a second set of layout attributes; and
instructions to compare the first set of layout attributes with the second set of layout attributes.

8. The non-transitory machine-readable storage medium of claim 7, further comprising:
instructions to generate a second combination of values, each value of the second combination of values selected from the values available for each context element of the set of context elements, wherein the second combination of values includes at least one value that is different from the first combination of values;
instructions to obtain a third UI based on the second combination of values, the third UI comprising a third set of layout attributes;
instructions to obtain, after the application has been modified, a fourth UI based on the second combination of values, the fourth UI comprising a fourth set of layout attributes; and
instructions to compare the third set of layout attributes with the fourth set of layout attributes.

9. The non-transitory machine-readable storage medium of claim 7, wherein obtaining the first UI based on the first combination of values comprises:
retrieving, from a data storage, the first UI that corresponds to the first combination of values; or
generating the first UI by applying the first combination of values to the application.

10. The non-transitory machine-readable storage medium of claim 7, wherein the first set of layout attributes comprises layout attributes associated with at least one context element of the set of context elements.

11. The non-transitory machine-readable storage medium of claim 7, further comprising:
instructions to identify a first context element of the set of context elements, the first context element having a first set of values available for selection;
instructions to identify a value that has been selected for the first context element; and
instructions to determine layout attributes associated with a second context element of the set of context elements based on the value that has been selected for the first context element.

12. A system for detecting user interface (UI) layout changes comprising:
a processor that:
generates a set of combinations of values from context elements that define a UI layout for an application, wherein each value in a combination of the set of combinations is selected from values available for each context element;
obtains a first set of UIs corresponding to the set of combinations;
obtains, after the application has been modified, a second set of UIs corresponding to the set of combinations; and
compares the first set of UIs with the second set of UIs to detect a mismatch.

13. The system of claim 12, wherein comparing the first set of UIs with the second set of UIs to detect the mismatch comprises:
comparing a first layout attribute of a context element in a first UI with a second layout attribute of the same context element in a second UI; and
detecting the mismatch when the first layout attribute is different from the second layout attribute.

14. The system of claim 13, the processor that:
generates an alert based on the detected mismatch, the alert indicating the context element in which the mismatch has been detected.

15. The system of claim 12, wherein the set of combinations comprises a first combination that includes at least one value that is different from a second combination.
